(19) United States
(12) Patent Application Publication
(10) Pub. No.: US 2004/0098747 A1
(43) Pub. Date: May 20, 2004

(54) Electronic buying guide architecture

(76) Inventors: Matthew W. Kay, Hingham, MA (US); Matthew J. Laughlin, Boulder, CO (US); Colin P. Campbell, Norwood, MA (US)

Correspondence Address: ANTONELLI, TERRY, STOUT & KRAUS, LLP, Suite 1800, 1300 North Seventeenth Street, Arlington, VA, 22209, US

(21) Appl. No.: 10/313,001

(22) Filed: Dec. 6, 2002

Related U.S. Application Data
(60) Provisional application No. 60/340,071, filed on Dec. 7, 2001.

(51) Int. Cl. H04N 7/16; H04N 11/04; H04N 11/02; H04N 7/12; H04N 7/173

(52) U.S. Cl. 725/95; 348/385.1; 725/87; 725/115; 725/145; 725/147; 725/117

(57) ABSTRACT

An interactive television commerce system, includes a video broadcast distribution network having multiple in-band channels and an out-of-band data path. A video on demand server stores a plurality of product video clips. Each of the plurality of product video clips is stored in association with a respective unique clip identifier and has video images promoting a specific product and associated interactive data embedded in the video images. A commerce transfer point server broadcast, via a first of the multiple in-band channels, a first commerce related video program having video images promoting multiple different products and associated interactive data embedded in the video images, and the unique clip identifiers associated with those of the stored plurality of product video clips having video images promoting the multiple different products promoted in the video images of the first commerce related video program. A network controller receives, via the out-of-band data path, a first of the unique clip identifiers broadcast with the first commerce related video program and associated with a first of the stored plurality of product video clips having video images promoting a user selected one of the multiple different products promoted in the video images of the broadcast first commerce related video program. The controller also directs a broadcast, via a second of the multiple in-band channels, of the stored first product video clip, based on the received first unique clip identifier. The video on demand server broadcast the stored first product video clip via the second in-band channel, based on the controller directive.

### FIELD OF THE INVENTION

This invention relates generally to an interactive television commerce system, and in particular, to an interactive shopping service.

### BACKGROUND OF THE INVENTION

The Internet is growing rapidly and has emerged as a significant interactive medium for entertainment, communications, research, education and e-commerce. However, Internet access generally requires a personal computer, and some consumers may have little need or desire for a personal computer, either because it can be costly, or because it can be difficult or complicated to use. For such consumers, it may be preferable to receive electronic information and entertainment services through their television sets. A television-based approach to e-commerce would appear to be an attractive alternative for many of these consumers as well as an appealing alternative for PC users.

Interactive television is developing rapidly and permits the viewer to participate in a wide range of activities, such as information retrieval, video games, and purchasing of goods and services. In a traditional cable or satellite television system, a set top box receives multiple channels of programming content from a cable or satellite television operator, and transmits to the television receiver the specific programming content on a channel selected by the viewer. The transmission of information occurs in one direction only, from the cable operator, via the set top box, to the television receiver for viewing by the viewer. In an interactive television system, by contrast, the set top box also functions as an intelligent communications terminal, and is able to store and run application programs that permit two-way communications between the viewer and the cable operator to support a wide variety of interactive functions.

Cable television system operators, referred to here as multiple system operators (MSO's), are currently deploying digital broadband delivery systems (DBDS's) capable of supporting interactive television commerce. The terminology used here is essentially that of Scientific-Atlanta, Inc., but the components described could be used in other systems. DBDS allows the MOSs to offer their subscribers digital content that looks better than cable transmitted analog programs, and allows more digital channels to run on the same cable wire (at least 8 times as many). DBDS also offers two-way messaging between the cable network and set top boxes, allowing MOSs to offer customers interactive applications such as video on demand and e-mail. DBDS is designed as a client server network with client applications running on set top boxes that communicate with an application server that provides the content for the client applications.

DBDS has several components that work together to deliver these broadband digital services to consumers. Analog set top boxes are replaced by digital set top boxes, referred to as digital home communications terminals (DHCTs). A DHCT is essentially a small network computer that provides a subscriber with the ability to run multiple applications. It also provides Internet protocol (IP) connectivity back to a server via a hybrid fiber coax (HFC) line wired to the subscriber's home to allow an application running on the DHCT to interact with the DBDS.

A digital network control system (DNCS) is a server, typically UNIX based, that controls the configuration of the entire DBDS, routine DBDS maintenance, SNMP monitoring, the broadcasting of data to the set tops, and the registering of additional applications that run on the DBDS. One DNCS can currently handle up to two hundred thousand subscribers.

A broadcast file system (BFS) is a component of the DNCS and is essentially a file system containing system data (such as DHCT configurations) and application data. This file system is continuously broadcast in a carousel fashion over the DBDS via an in-band data path (IDP) and an out-of-band data path (ODP). DHCTs can then access the BFS in much the same way that a PC accesses a hard drive.

The IDP is a 27 Mbps data channel that the DHCTs tune to, much like any other programming channel. The path is physically provided by a broadband integrated gateway (BIG) and an in-band quadrature amplitude modulator (QAM). In essence, these pieces of hardware are employed to create a 27 Mbps path over which the BFS is continuously broadcast to the DHCTs. Once the DHCT is tuned to the data channel, it can read the BFS data carousel at this high speed. This is useful for loading a new application on the DHCT as well as in any situation where fast access to the BFS is required. The IDP is one-way; no programming content can be received while the IDP data is being read.

The ODP is a data channel that can be accessed while programming content is being sent to the DHCT. The two components that make up the ODP are a forward data channel (FDC) that broadcasts out of the DHCTs and a reverse data channel (RDC) that receives data from the DHCTs, both at T1 speed. The FDC interface to the HFC is provided by a quaternary phase shift key (QPSK) modulator. The RDC interface to the HFC is provided by a QPSK demodulator. In essence, this equipment functions as a modem to bridge the DHCT to an Ethernet component of the DBDS. The FDC and RDC are used by server applications to communicate with the DHCTs.

Cable headend application servers reside on the same IP network as the DNCS, and provide a hardware platform for running server-based software applications that will be provisioned to the DHCTs, such as video on demand and email. Services that run in the DBDS have a component running on the application server and are registered with the DNCS.

### BRIEF DESCRIPTION OF THE DRAWINGS

FIG. 1 is a block diagram of a commerce control network according to the present invention.

FIG. 1A is a functional block diagram of the integration of a VOD server with the commerce control network.

FIG. 2 is a software process diagram of the commerce applications server.

FIG. 3 is a software process diagram of a headend database server.

FIG. 4 is a block diagram of a commerce control point.

FIG. 5 is a functional block diagram of a set top box and other items comprising a typical user station.

FIG. 6 is a diagram of the user interface rendered by the client application showing the mall directory.

FIG. 7 is a diagram of the user interface rendered by the client application showing a typical store.

FIG. 8 is a table detailing the navigational rules of each element of the interface shown in FIG. 7.

FIG. 9(A) is a first series of screenshots showing a typical purchase sequence.

FIG. 9(B) is a second series of screenshots showing a typical purchase sequence.

FIG. 9(C) is a third series of screenshots showing a typical purchase sequence.

FIG. 9(D) is a fourth series of screenshots showing a typical purchase sequence.

FIG. 9(E) is a fifth series of screenshots showing a typical purchase sequence.

FIG. 9(F) is a sixth series of screenshots showing a typical purchase sequence.

FIG. 9(G) is a seventh series of screenshots showing a typical purchase sequence.

FIG. 9(H) is an eighth series of screenshots showing a typical purchase sequence.

FIG. 9(I) is a ninth series of screenshots showing a typical purchase sequence.

### DETAILED DESCRIPTION

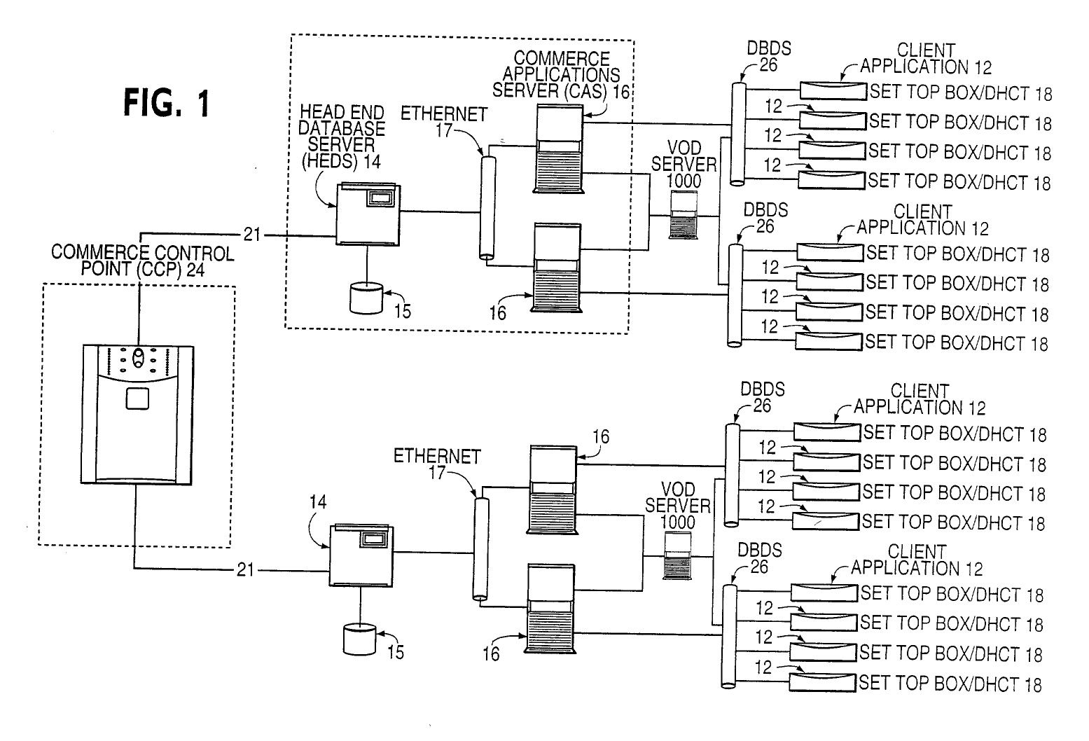

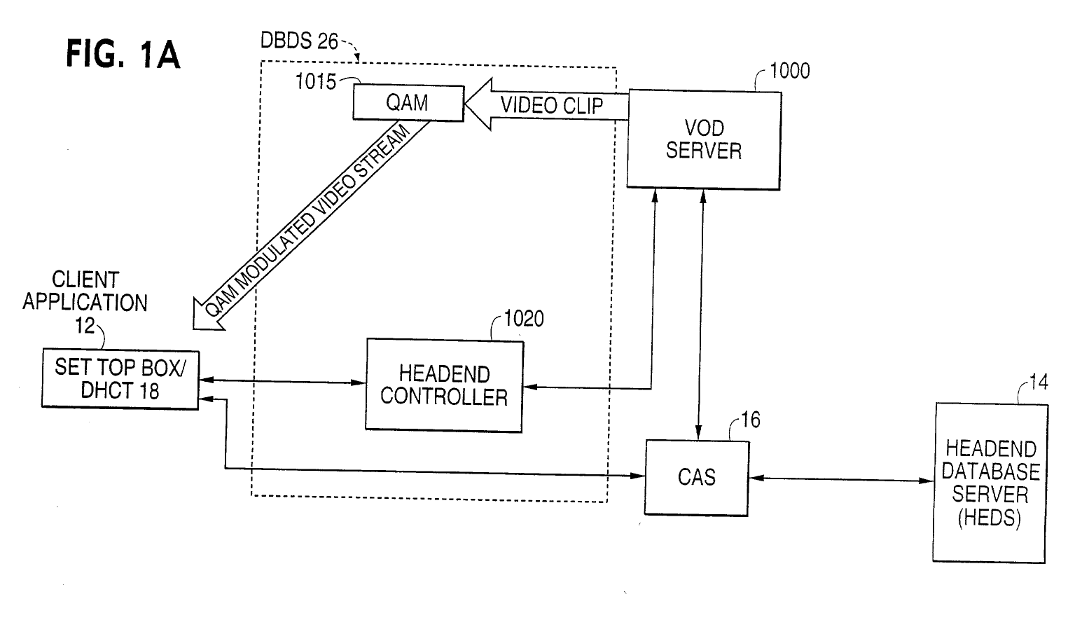

Referring to FIG. 1, the present invention includes an interactive television commerce system, referred to as a commerce control network (CCN) 10, in an interactive television system, such as a cable television system described above or a satellite television system, that is widely available to a large number of users, e.g., over a metropolitan area. CCN 10 allows TV users to select, purchase, gain additional information about, and store information relating to products using a simple and convenient menu-based user interface. The system can provide product lists that may or may not be customized based on a particular channel or demographic, or the product lists or other information can be tailored to the individual user.

In one instance of the system, if a user orders a product, the order can be processed by the system, the user's credit card may be billed, inventory may be updated, and the order may then be forwarded to a warehouse or other third-party fulfiller for shipment. In another instance, if a user orders a product, the order can be processed by the system and then forwarded to an appropriate third-party vendor for billing and fulfillment. In the latter instance, periodic status updates on the order may be provided by the vender to the system. The system, referred to here as an electronic buying guide (EBG), is not strictly limited to “buying,” but can also include obtaining product information, product samples and other content.

CCN 10 of the present invention has a three-tiered architecture with client applications 12; a commerce transfer point (CTP) 22, and a commerce control point (CCP) 24.

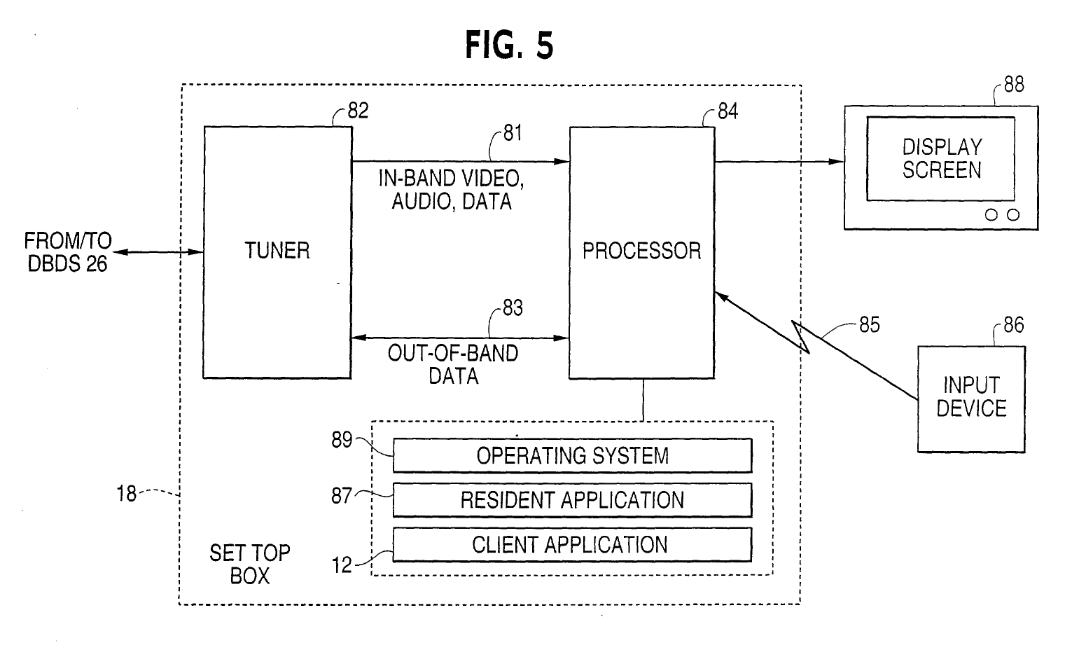

FIG. 5 shows a functional block diagram of a set top box 18, and other items comprising a typical user station in the commerce control network 10 of FIG. 1. Client application 12 runs on processor 84 under a set top operating system (OS) 89, such as the PowerTV Set Top OS, which is currently being provided with a Scientific-Atlanta DHCT, or under a Windows CEOS. In the case of the PowerTV OS, client application 12 may be created using a PowerTV development kit. The PowerTV OS provides a full-featured application programming interface (API) that allows a developer to isolate the application code from the hardware level of the set top box.

Client application 12 provides the user with a convenient user interface that is controllable by the user with an input device 86, preferably a standard STB remote control, to allow viewing, purchasing, or obtaining information about products. The input device may be connected to STB 18 directly or, more typically, by infrared link 85. The viewer can thus conveniently access the application via a remote control button while watching television.

As will be explained in further detail below, client application 12 directs the display of product related information on a display screen 88, usually a standard television set, and can do so simultaneously with display of the programming to which STB 18 is tuned. A tuner 82 can be tuned to a multiplicity of broadcast channels on a broadcast distribution network (DBDS) 26 to receive in-band video, audio and data 81, for display to the user.

The functionality to call the client application is built into a resident application 87 that runs on STB 18 and can be provided by a variety of third party vendors. A client application executable is loaded onto STB 18 from broadcast distribution network (DBDS) 26 when resident application 87 determines that the user has tuned to a channel that is configured to run the client application.

In addition to in-band path 81, tuner 82 also provides a bidirectional out-of-band data path 83 over which processor 84 sends transaction requests, generated in response to user inputs, to CTP 22, and over which processor 84 can receive product related data from CTP 22.

The term “set top box” is meant broadly to include a processing functionality with a television set; that functionality could be integrated into the television set itself, for example, and thus need not be literally in a separate standalone “box.”

Again with reference to FIG. 1, CTP 22 includes one or more commerce application servers (CAS) 16, each in communication with a number of set top boxes; one or more headend database servers (HEDS) 14, each connected to one or more CASs; a private Ethernet network for connecting CASs and HEDSs; and a private wide-area network connection 21 for communication with CCP 24. CTP 22 handles all of the requests from the client applications 12, and serves as a data conduit to CCP 24. In the case of a cable television system, the CTP is preferably located at the cable head-end.

CAS 16 is responsible for registering CTP 22 for use within the DNCS of the local MSO, and for providing client application 12 to DBDS 26 for distribution to set top boxes 18. The CAS also serves as the point of communication between client applications 12 and HEDS 14, and thus CAS 16 handles all client application 12 requests and forwards them to HEDS 14. The number of CAS 16 machines may be set as needed based on the number of STBs 18.

CAS 16 is preferably implemented by a small server, such as a Compaq Proliant Model 1600R running Windows NT, preferably with message queuing software such as Microsoft Message Queue (MSMQ). CAS 16 utilizes at least one Ethernet card to access HEDS 14 and at least one asynchronous transfer mode (ATM) card to access DBDS 26 via an ATM switch, such as a Xylan ATM switch. The system can have one more CAS 16 than is needed to handle usage so that in the event of a failure of one CAS, the overall system will still handle the full processing load.

The Interactive Shopping service utilizes a VOD server 1000 to provide both broadcast video and video-on-demand functionality in support of the service. Each interactive store has a corresponding 512 kbps MPEG digital broadcast stream running a video of any length, such as thirty minutes, that has been preprocessed to mimic a quarter screen capture window. This allows the application to maintain reasonable picture quality while minimizing bandwidth consumption. It also allows the service to be offered on set top boxes that do not have video scaling capability, such as the Motorola DCT 2000.

In addition to supporting the broadcast channels for virtual interactive stores, the VOD server 1000 is also responsible for providing the video-on-demand functionality in support of individual product video clips. When a viewer requests a product video to be shown, the VOD server 1000, in conjunction with the head-end controller 1020, provides a short VOD session to enable the functionality. Since the video clips are short in duration (approximately two minutes), the traffic engineering for the VOD sessions should be more akin to telephony traffic engineering, allowing a more efficient use of the bandwidth.

With reference to FIG. 1, VOD server 1000 includes a video on demand server that is integrated into the headend to allow for the set up and control of individual video sessions that are streamed to individual set top boxes. The server will be detailed below in FIG. 1A.

VOD server 1000 is what provides the interactive shopping service with broadcast video and video on demand capabilities. The VOD server 1000 performs two functions. First, it broadcasts some number of channels for each of the stores to display their promotional videos. It intermittently broadcasts 30-minute or 60-minute promotional videos on a specific defined channel dedicated to a particular store.

The video on demand server also stores product video clips so that they can be accessed in an on-demand fashion by the set top box when the user indicates he or she would like to see a video about a product being browsed.

There are two functions associated with the VOD server 1000. First, all of the product videos must be provisioned to the video on demand servers across multiple headends. The video itself is stored in the CCP 24. From there, it is distributed down to the headend database server 14. The broadcast server function of CAS 16 extracts the video from the HEDS 14 and delivers it to the VOD server 1000. The CAS 16 then returns to the HEDS 14 the unique key that the VOD server 1000 used to identify that particular piece of video and the location in which it is stored. This is done because later when the user is interacting with the set-top application and wants to play a particular video, the set-top application must be able to provide that key to the VOD server 1000 in order to access the correct video.

The final responsibility of the broadcast server function of CAS 16 is to extract video media from the HEDS 14 and deliver this media to the VOD server 1000. The media could be thirty-minute promotional videos that are broadcast continuously, or two-minute, on-demand video clips associated with individual products. In the process of provisioning the video to the VOD server 1000, an index to reference the video is returned by the VOD server 1000. That index is written to the HEDS 14 by the broadcast streamer function of CAS 16 and then extracted as part of the enhancement. In this way the provisioning loop is closed, allowing users to play video clips for products on-demand.

With reference to FIG. 1A, HEDS 14 is where the physical video actually resides. The CAS 16 pulls the media from the HEDS 14. It then delivers that media, following the video delivery line to VOD server 1000. VOD server 1000 receives the video and stores it on its local hard disk. It then returns a key or unique identifier that it uses to reference that particular individual piece of video to the CAS 16. The CAS 16 then sends the VOD key back to HEDS 14 to be stored in the HEDS 14. It is in this manner that VOD videos are provisioned whether they are broadcast video, or individual product video clips to be viewed on demand only.

The second step in this process is extracting the interactive data that is used in conjunction with the broadcast video. The CAS 16 in FIG. 1A extracts text and images that describe individual stores such as the Pottery Barn or Crate and Barrel, for example. It formats all of that data into a known data format that includes all the products for sale, all of the departmental menu hierarchies - e.g., ten departments, twelve sub departments underneath each department, and the products themselves. The data is embedded in the actual JPEG images that are displayed on-screen. The CAS 16 also inserts the VOD key. that was stored in the HEDS 14 during the VOD provisioning function. Once the CAS 16 pulls together all of this information, it then inserts that data into the broadcast stream along with the actual video that is playing for the particular store. For example, it inserts Pottery Barn's data into the Pottery Barn frequency, embedding it with the video and audio. When the consumer is tuned to the Pottery Barn store on the interactive shopping service, he receives the audio and video that is being broadcast from the VOD server 1000. The products, departments, images and all other data that was packaged are also streamed to the client application. This is how the system delivers the content that is to be displayed to the user by the client application 12.

When the user navigates down to an individual product and wants to view more information on it, he can view the two-minute video clip provided via the video on demand component of the interactive shopping service. The video clip for the product was provided to the VOD server 1000. Server 1000 sent back through the CAS 16 to the HEDS 14 the VOD key to be used. That key was sent to the set top box along with the product information to associate it with the correct video. The client application 12 requests that particular video using an industry standard format called digital storage media command control language (DSMCC). The client application 12 sends a message to the headend controller 1020 that identifies the particular set top box and provides the key to the particular video. The headend controller 1020 then communicates with the VOD server 1000 and requests the video. The VOD server 1000 confirms the video is available and inquires whether or not the headend controller 1020 has a QAM 1015 available. The QAM 1015 is responsible for modulating data onto a specific frequency in the cable headend. The headend controller 1020 identifies a QAM 1015 that the VOD server 1000 can be used to deliver the video on a specific frequency or channel. The VOD server 1000 then completes the exchange with an acknowledgement that it is going to start streaming the video associated with the video identifier key on the particular QAM 1015, and then starts streaming it. The headend controller 1020 then instructs the set top box to tune to the correct frequency. At that point, the set top box tunes to the frequency and displays the video session. In addition, this DSMCC link can also be used to fast forward or pause the video in a manner akin to the functioning of a typical VCR.

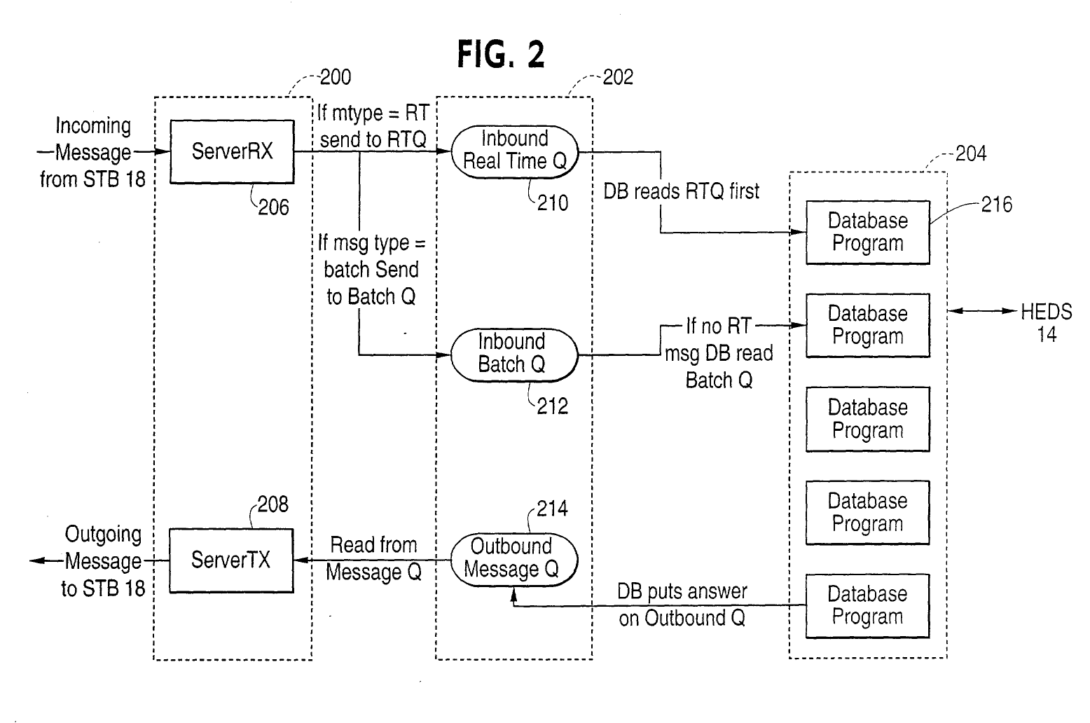

Referring to FIG. 2, CAS 16 has three software components: (i) socket server process 200, which manages the client TCP/IP connections; (ii) message queuing component 202, which provides the message queuing functionality; and (iii) database process 204, which processes client requests and provides database access.

Socket server process 200 has at least two functions: a receive service, ServerRX 206, and a transmit service, ServerTX 208. ServerRX 206 manages client connections from a number of client applications 12, reads the client requests, and puts each such request message in an appropriate inbound queue in message queuing component 202 based on header information contained in the request. ServerTX 208 scans the outbound queue of message queuing component 202 for replies from the HEDS 14, opens connections to the appropriate client applications 12, and forwards the replies to the clients.

Message queuing component 202 is preferably implemented as multiple queues. For ServerRX 206 communications, there are at least two queues: inbound real time queue (IRTQ) 210 and inbound batch queue (IBQ) 212. The request messages from the client applications have header information that indicates the response priority. A client application request whose header information indicates that the request requires an immediate answer will be placed in the real time queue 210. A client application request whose header information indicates that the request does not require an immediate answer will be placed in the batch queue 212.

Database process 204 has a number of 'single database programs 216, each of which can service incoming client application requests from message queuing component 202. Each database program 216 processes one inbound request from message queuing component 202 at a time. Each database program 216 first processes requests in IRTQ 210. If IRTQ 210 is empty, each database program 216 processes requests in IBQ 212. Database program 216 can then submit a request to the associated HEDS 14 and wait for a reply. When a reply is received, database program 216 forwards that reply to outbound message queue (OMQ) 214. Messages are retrieved from OMQ 214 by ServerTX 208, which functions as described above.

The use of these multiple queues and database programs helps make possible the processing of a large number of requests by users through their client applications at the same time.

Referring again to FIG. 1, each CTP 22 contains at least one HEDS 14 to provide all persistent data storage, including customer information, order status, program data, item information, and item descriptions. HEDS 14 is preferably implemented by a small server, such as a Sun Sparc 1 running Solaris or an IBM R56000 Model C20 running AIX, and preferably with a relational database management system (RDBMS) 15, such as an Oracle RDBMS. The use of an RDBMS is desirable because an RDBMS allows for scalable access to large amounts of data. HEDS 14 preferably has at least one Ethernet card to communicate with one or more CASs 16 via a private Ethernet network 17 and at least one Ethernet card to communicate with CCP 24 via wide-area network 21. HEDS 14 also has a console for either local or remote maintenance and operation. The HEDS can be physically located in one headend, or can be off-site but still logically part of the CTP. This allows for one HEDS to serve more than one headend if desirable.

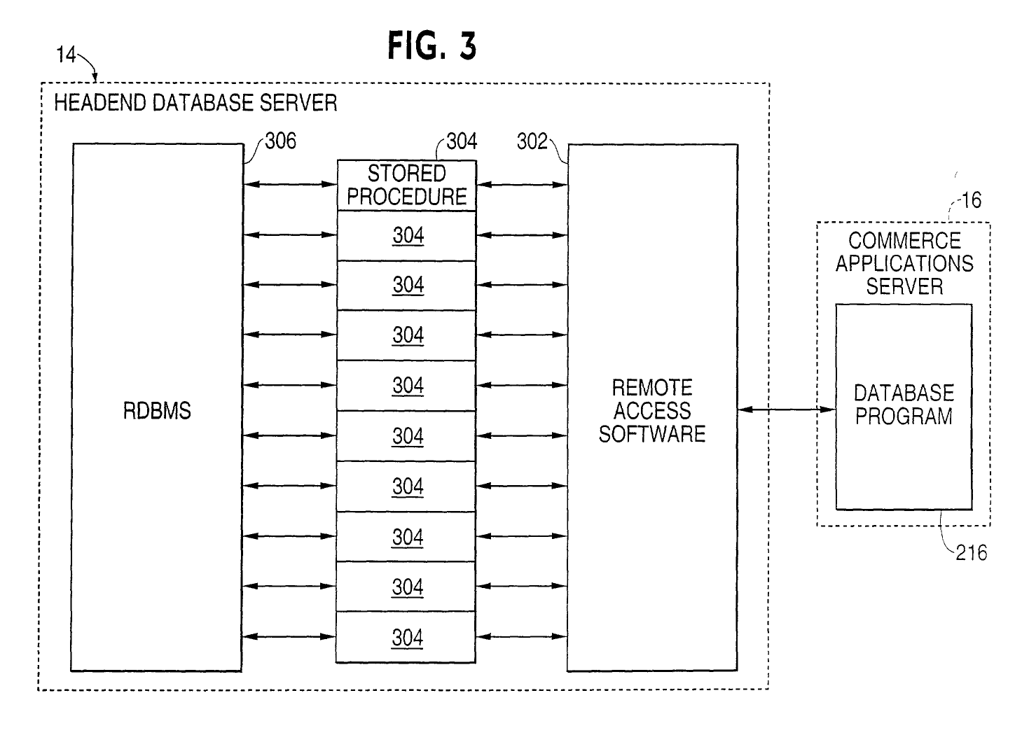

Referring to FIG. 3, database program 216 submits requests to HEDS 14 via remote access software 302, such as Oracle SQL*NET. The requests include information for directing HEDS 14 to execute any one of a number of stored procedures 304 on RDBMS data. Stored procedures 304 contain the business logic for supporting certain applications in the network.

RDBMS data is populated by multiple sources. These sources include CCP 24, which can provide data such as broadcast schedules, product lists, product information, product videos and order status information; CAS 16, which provides data from user inputs such as credit card data, pass codes, multiple user profiles and specific transaction information; and an MSO billing system, which provides household-specific information including name, address, telephone number, and a unique identifier for a user's STB.

HEDS 14 combines specific transaction information with credit card information and household specific information and forwards the combined information to CCP 24 in a real-time or in near-real-time fashion at a pre-set interval, which may be different for different types of information (e.g., general requests for information may be transferred at a slower rate than orders from customers to purchase products). The CCP thus replicates what is in the various HEDSs 14 in communication with it. HEDS 14 also monitors portions of the system to ensure proper operation and generates alarms to CCP 24 when problems are detected.

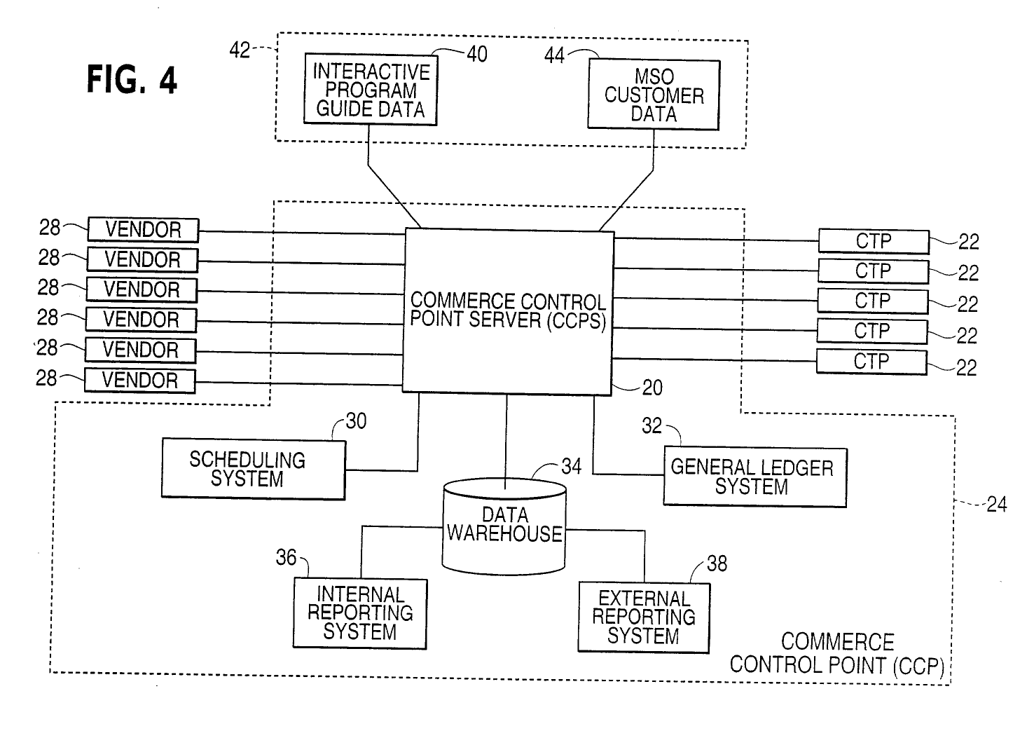

Referring to FIG. 4, commerce control point (CCP) 24 preferably includes at least one of each of the following components: a CCP server 20, a scheduling system 30, a general ledger system 32, a data warehouse 34, an internal reporting system 36 and an external reporting system 38. CCP server 20 can be a large, highly available UNIX-based server with a separate disk farm and an RDBMS. Scheduling system 30 can be a UNIX-based server with an RDBMS. General ledger system 32 can be a component of a standard accounting system software package. Data warehouse 34 can be a large UNIX-based server with a separate disk farm and an RDBMS. Each reporting system can be a Windows NT workstation. CCP 24 may reside at a dedicated location or locations such as a collocation area of a telephone company central office or point of presence. CCP 24 also performs various maintenance and monitoring functions on its own systems to alert operators when any problems are detected.

CCP server 20 communicates bi-directionally with one or more commerce transfer points (CTPs) 22 and provides data, including broadcast schedules, product lists, product information and order status information, to each such CTP 22. CCP server 20 also aggregates user data in order to create user profiles. These user profiles can be used to target content to individual users or groups of users

CCP server 20 interfaces with vendor e-commerce systems 28 to forward sales orders, obtain inventory control information, authorize and settle credit card transactions, and provide order fulfillment. CCP server 20 can have a number of external data feeds 42. In the preferred embodiment, these feeds include a link from MSO billing systems providing MSO customer data 44 which includes the customer name, address and phone number associated with a unique set top box identifier.

Scheduling system 30 accesses raw vendor product lists from CCP server 20, and provides to vendors a web-based interface for each vendor to designate which products from such vendor's raw product list are to be offered at which times. The scheduling system then forwards the configured information back to CCP server 20, which in turn forwards the configured information to the appropriate CTPs 22.

General ledger system 32 can record all of the commerce control network's billable transactions downloaded from the CCP servers 20, and then can aggregate transaction information on a vendor-by-vendor basis for invoicing and financial reporting. Ledger system 32 can perform a similar function for other network participants such as MSOs.

Data warehouse 34 stores a near-real-time image of all of the data resident in each of the CCP servers 20. This data is used by internal reporting system 36 and external reporting system 38 to generate detailed reports without using the processing resources of the CCP server. Internal reporting system 36 generates reports relevant to the operation of the CCN, such as exception reports and CCN marketing reports. External reporting system 38 generates reports configured in any reasonable manner deemed useful by vendors or other CCN participants, such as vendor sales and demographics reports.

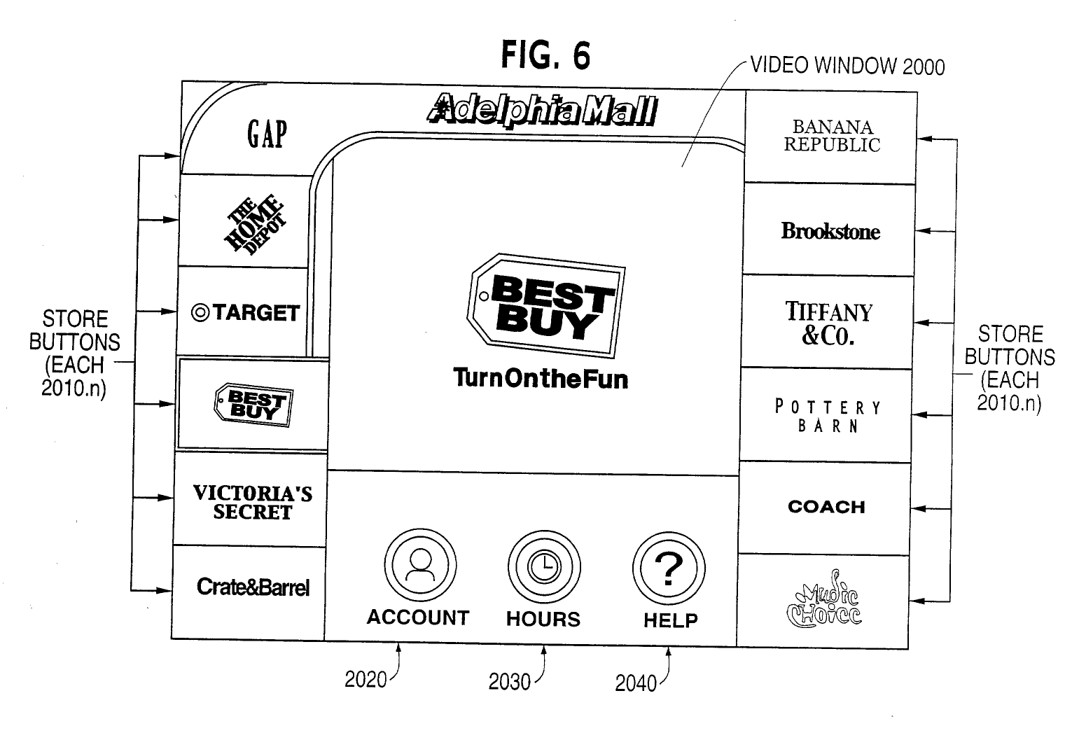

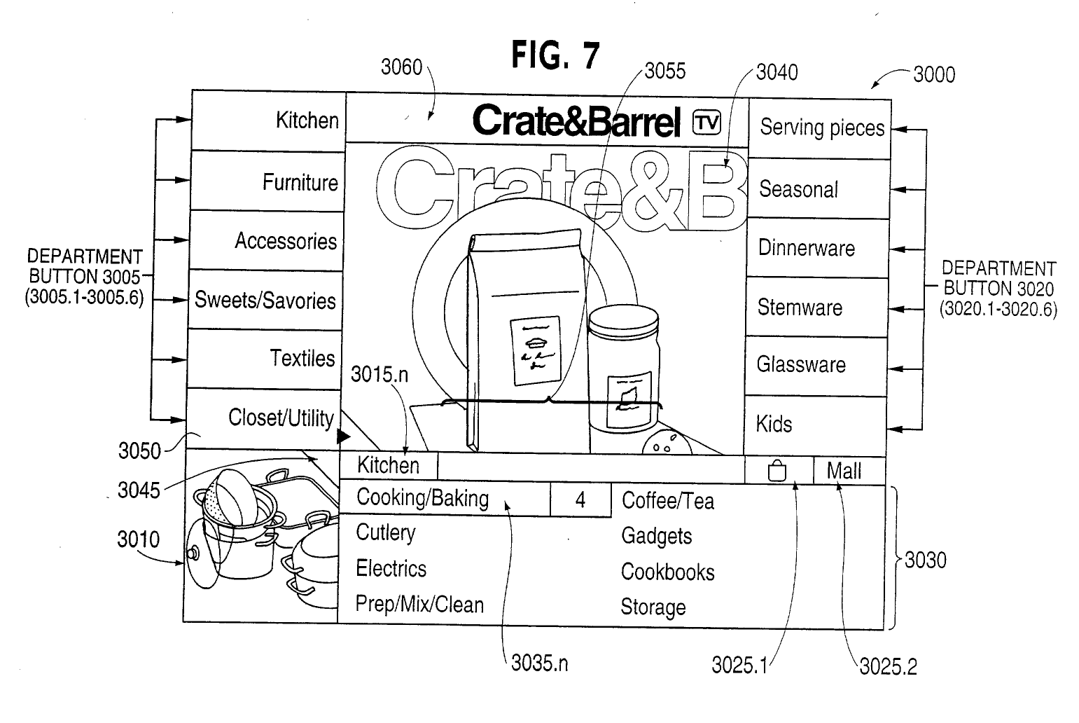

The first part of the interface is the mall directory that contains a series of stores within it. FIG. 6 shows the mall directory with a series of store buttons 2010 on each side, which is the opening screen of the application. The concept of the mall directory in general is a metaphor of a traditional brick and mortar mall directory with a series of stores within it. This is implemented via a graphical user interface on the screen delivered over broadcast channels. The base mall directory graphical user interface shown in FIG. 6 displays a video window 2000 in the center. This video window 2000 can be used to broadcast a generic promotional video of all of the stores in the mall. Each of the store buttons 2010 is aligned along the side of the application requiring the user to simply press select on the remote control 86 to cause the client application to display that store's user interface. Upon doing so, the client application 12 causes the set top box 18 to tune to a specific broadcast frequency that is showing the broadcast video for the selected store. FIG. 7 shows, for example, Crate & Barrel. When the set top box is tuned to Crate & Barrel's channel, the client application starts to receive data on all of Crate & Barrel's products and services and tunes to Crate & Barrel's promotional video, which is different from the main promotional video of the mall directory. In essence, the mall directory is provisioned on one channel, and the Crate & Barrel store, like all stores, is provisioned on its own channel.

When a set top box 18 is tuned to a store, a video for the store is played and the user interface of the store is displayed. Once all of the store data has been received, the video for the store highlights specific products that are for sale within the store. Those products have broadcast data triggers embedded in the video that enable an auto-browsing effect. As a new product is displayed in the video window 3040 as part of the store's promotional video, the associated text data for that product is auto-browsed through the user interface and displayed to the user in the detail box 3030, while, a picture of the product is displayed as a thumbnail image 3010. The user can, at any time, take control of this auto-browse feature and enter a manual browse mode by pressing any arrow key on his remote control. After a predetermined length of inactivity from the user, the client application 12 will “time out” and resume the auto-browse mode.

When the user selects a product, he or she receives more detail about it that is displayed in detail window 3030 and thumbnail image 3010 or video window 3040. That detail can include a longer text description and image of the product, as well as pricing and shipping information, etc. With respect to the thumbnail image 3010, each image can also have a large image associated with it, the availability of which is indicated by a graphic 3045. When the user presses select on an image that includes such an indicator 3045, the larger image is displayed in the video capture window 3040.

Similar to the availability of larger images, products can also be associated with product video clips. Those video clips are provided by the VOD server 1000. The user navigates to the thumbnail image that includes a graphic indicator 3050 indicating that there is a video clip. When the user presses select on a thumbnail image 3010 containing an indicator 3050 that a video is available, the application communicates, as previously discussed, through the headend controller 1020 to the VOD server 1000. The set top box 18 tuner 82 tunes to the individual session designated for the particular video by the VOD server 1000. A video session is established and the user sees the short two or three-minute product video. At that point, the user is also provided with standard VCR-like functionality to control the video (i.e., pause, rewind, fast-forward, etc.) using graphical, on-screen controls 3055. At the end of the session, the set top box 18 retunes to the store's broadcast video frequency.

All of the content—i.e., stores and products within stores—is provisioned using a scheduling system. The database scheduling system pushes product information through the CAS 16 to the set top box to populate the stores and content within the mall directory. The scheduling system facilitates having more stores in the mall directory than are available at any one time. For example, if at one time of the day—i.e., noon—there are 12 stores in the mall directory, at a later time of the day—i.e., 6 PM—there could be 12 different stores because the scheduling system drives different content to the set top application at different times. In addition, the content within a store can be scheduled such that the HEDS 14 and its scheduling system push different products into the same store at different times.

For example, during the day between the hours of 2 and 4 PM, it may be preferable to have one of the available stores be a toy store. In theory, that would generate more sales than having that same toy store available from 11:30 at night until 1 AM because in the middle of the day children are home and they are most likely to browse through the toy store and select products. For that reason, the system allows for dynamic store data to be sent down so that the toy store can be made available and broadcast down at 2 o'clock in the afternoon. Thus, at 11 o'clock at night, the toy store can be substituted with a sporting goods store, or some other store that would be more appropriate for that television viewing demographic.

Assume the sporting goods store were available at both times. During the afternoon, sporting goods geared towards children such as basketballs, baseballs, etc., would be offered. In the evening, golf clubs and tennis rackets, and more adult-focused sporting goods could be offered. In this way, actual product data in a store can be scheduled and tailored to a particular television viewing demographic at a particular time.

If the user would like to know when a certain store will be available in the mall, he need only select the Hours button 2030 shown in the mall directory in FIG. 6. The store schedule is then displayed to the user in the video window 2000.

Referencing FIG. 1A, the scheduling of mall and product data works the same way. The data itself and its scheduling information are stored in the HEDS 14. The CAS 16 continually poles the HEDS 14 for information scheduled for the current time. When it poles the HEDS 14, the HEDS 14 pushes out the appropriate data for that particular time to the CAS 16 which then multiplexes that data with the appropriate broadcast video and sends it down to the set top box. This ensures that at any given time the intended suite of stores is made available in the mall directory, and further, that within a particular store, the intended products are made available.

Mall User Interface FIG. 7 shows the layout, navigation and functionality of a specific store within the mall. The interface of each store is organized into seven areas. The first area is the department list running down the left side of the screen. The width of the department list is approximately ⅕ of the screen and it is a list of six department buttons 3005. Beneath the department list is the second area. This is the thumbnail image 3010 area of the screen. This area of the screen is used to display an image of the sub-department that is currently selected, or it is used to display the image for the specific product that is currently selected. The third area is a combination of the tab 3015 and detail box 3030 areas at the bottom of the video window 3040, to the right of the thumbnail image 3010. In the tab area, the application displays various tabs for sub-department product information and purchase sequences, and the detail box 3030 displays the corresponding detail. The fourth area of the user interface is the right department list 3020. The right department list occupies approximately 1/5 of the horizontal space of the screen and contains a list of six department buttons 3020 stacked on top of another, running down the right-most side of the television screen. Beneath the right department list is the fifth area 3025. This is a very small area of the television's screen that contains two buttons. The combined width of the buttons is the same as the width of the right department list. One button is the checkout button 3025.1 and the other is a mall directory button 3025.2 that returns the user from the current individual store to the mall directory shown in FIG. 6. The sixth area of the interface is the banner area 3060, centered at the top of the television screen between the left department list 3005 and the right department list 3020. It is a banner used to display graphics, typically the logo of a specific store. The seventh area is the video viewing window 3040 in the center of the screen, between the left and right department lists, beneath the banner 3060 and above the tab area 3015. The video window 3040 is used to display a scaled-down video or to display a large still image.

Referring to FIG. 7, users of the application can navigate through the application by using the four arrow keys (Up, Down, Left, Right) and the select button on the remote control 86. Navigation is best described with reference to particular navigational concepts. The first concept is the “in-focus” concept. In-focus means that a particular element in the. user interface is active, or in-focus to the subscriber. For example, referring to FIG. 7, the top left-most department is in-focus if a bright, highlighted border is around the department that is different than the border around the other eleven departments, and can include the department or item appearing as a contrasting color. When a user presses select on a department that is in-focus, the corresponding tab in area 3015 of FIG. 7 will represent the corresponding data that is associated with the in-focus department. For example, the in-focus Kitchen department 3005 of FIG. 7 results in Kitchen department detail being displayed in area 3015 of FIG. 7, and the first detail item 3035.1 is in-focus.

With regard to the navigation, the user can only move the in-focus highlight through the application interface to an area that is adjacent to the area that is currently in-focus. For example, the top-most department button on the left side 3005.1 is the Kitchen department. If the Kitchen department is shaded a different color than the other departments and has the in-focus highlight around it, then the user can navigate to the department directly beneath it or adjacent to it by pressing the down arrow. The user can also navigate to the top-most department in item 3020 in FIG. 7, the Serving Pieces department, by clicking the left arrow button. Although the Serving Pieces department is physically to the right of the Kitchen department, between the departments is a non-navigable area, the banner area 3060 of the screen. Using the concept that the user interface is a wrapped user interface, the user is able to navigate from the Kitchen department 3005.1 to the Serving Pieces department 3020.1 by pressing the left arrow button because they are logically adjacent to one another. Similarly, if the in-focus element is the Serving Pieces department 3020.1 of FIG. 7, the user can press the right arrow button and the in-focus element will be moved to the Kitchen department 3005.1.

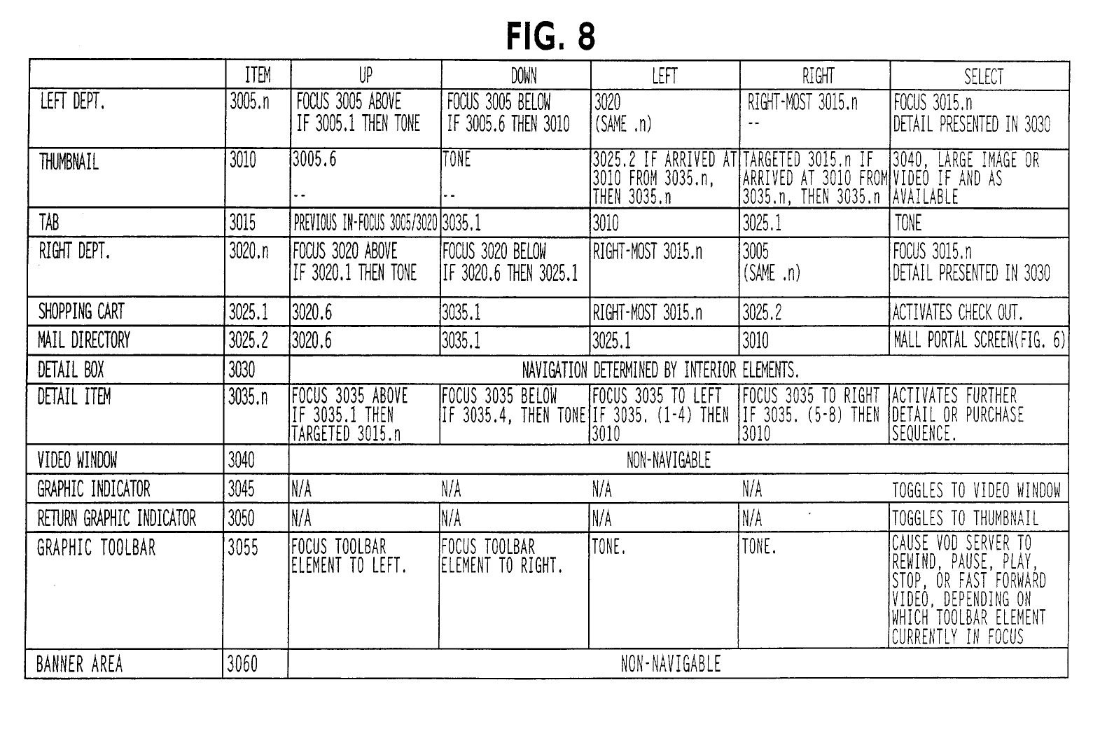

Referring to FIGS. 7 and 8, the behavior of each element of item 3000 must be described. The first item is 3005. When any of items 3005.1 through 3005.6 is in-focus and the up arrow is pressed, item 3005.n immediately above it is brought into focus. The exception is the top department 3005.1, in which case a tone will be heard signifying to the user that they cannot navigate any higher. If the down arrow is pressed, similar behavior is exhibited where the item immediately below is brought into focus, except in the case of the bottom department 3005.6, for which the in-focus item would become item thumbnail image 3010 just below the bottom department 3005.6. If any one department 3005.n is in-focus and the user presses a left arrow, the in-focus box logically “wraps” around the screen and brings into focus the corresponding department 3020.n. Thus, if 3005.3 is in-focus and the user presses a left arrow, 3020.3 is brought into focus. Finally, if the user presses select on a 3005 item, it will become shaded and the first item in that department's list of sub-departments in the detail box 3030 is then brought into focus (as is the current state of the application as depicted in FIG. 7). For example, if the Kitchen department 3005.1 is selected, the Kitchens tab 3015.1 and its sub-departments are displayed in the detail box 3030, and the first sub-department (Detail Item 3035.1) is in-focus.

Much like 3005, each of the 3020 elements behave the same way, such that the up arrow moves the in-focus box to the item above and a down arrow brings into focus the item below. If 3020.1 is in-focus, an up arrow would result in a tone being sounded. A down arrow pressed on 3020.6 will bring the user to 3025.1. If a left arrow is pressed, the right-most tab item 3015.n is brought into focus. If a right arrow is pressed, the in-box wraps around to the corresponding 3005.n. And finally, if select is pressed on 3020.n, the same thing happens as with 3005 and the user is brought to the corresponding tab item 3015.n with its detail displayed in detail box 3030.

With respect to the thumbnail image 3010, if an up arrow is pressed, the in-focus box moves to the last department 3005.6. If the down arrow is pressed, a tone sounds indicating the user cannot go any further. A left arrow moves to the mall button 3025.2. In the event the in-focus box is moved to 3010 from one of the 3025.n detail items, then a left arrow would instead return to the 3035.n detail item.

This functionality is the same type of wrapping functionality that occurs, for example, when a user presses the left arrow on a 3005.n item. When a user presses the left arrow, it actually brings into focus an item on the right edge of the screen. If item 3010 is in-focus and a right arrow is pressed, it brings the cursor in-focus on the right-most tab 3015.n. If the user had arrived at 3010 from a detail item 3035.n, a right arrow would instead return the in-focus box to that detail item 3035.n. Finally, if “Select” is pressed while 3010 is in-focus and either a video or a larger image is available, the visual will be displayed in video window 3040.

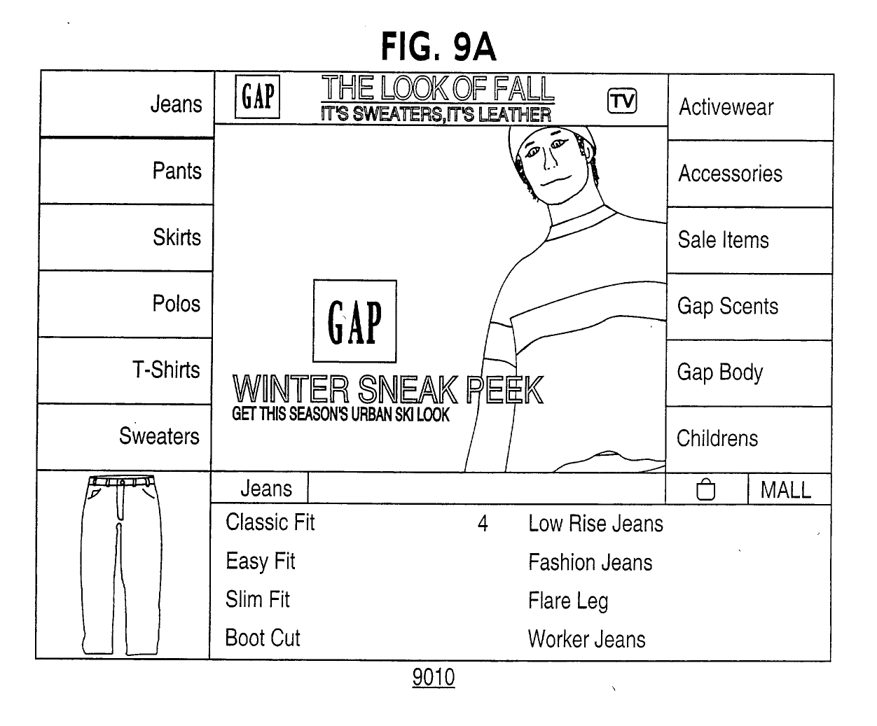

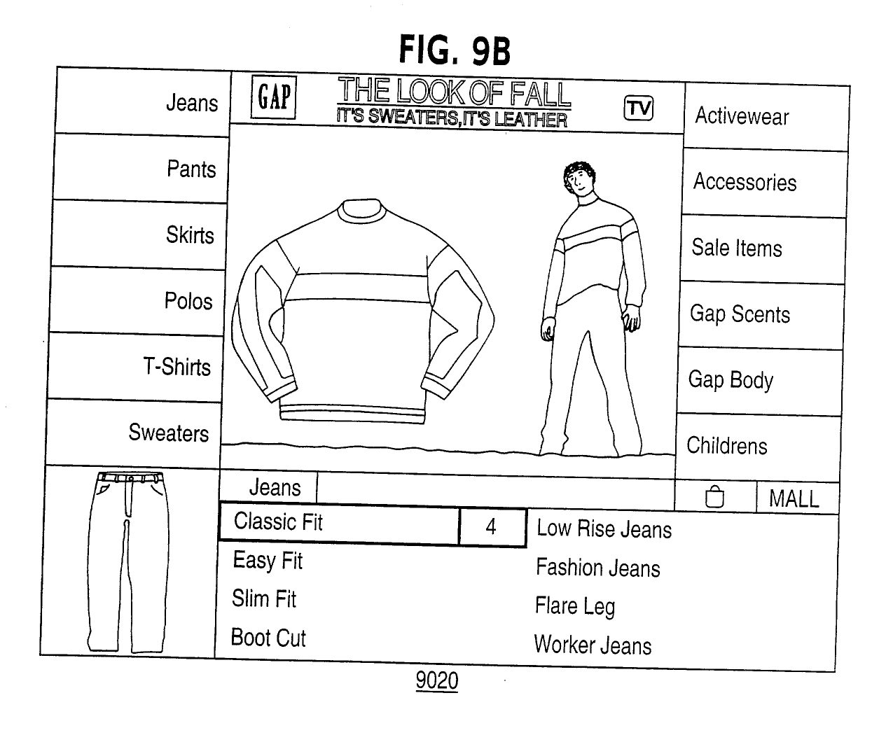

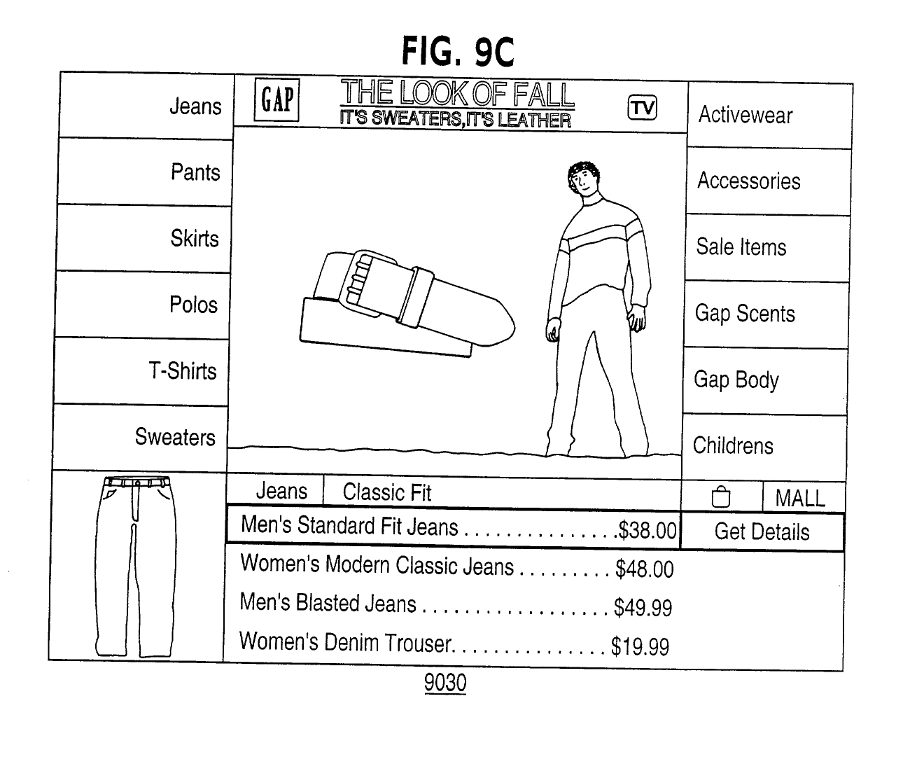

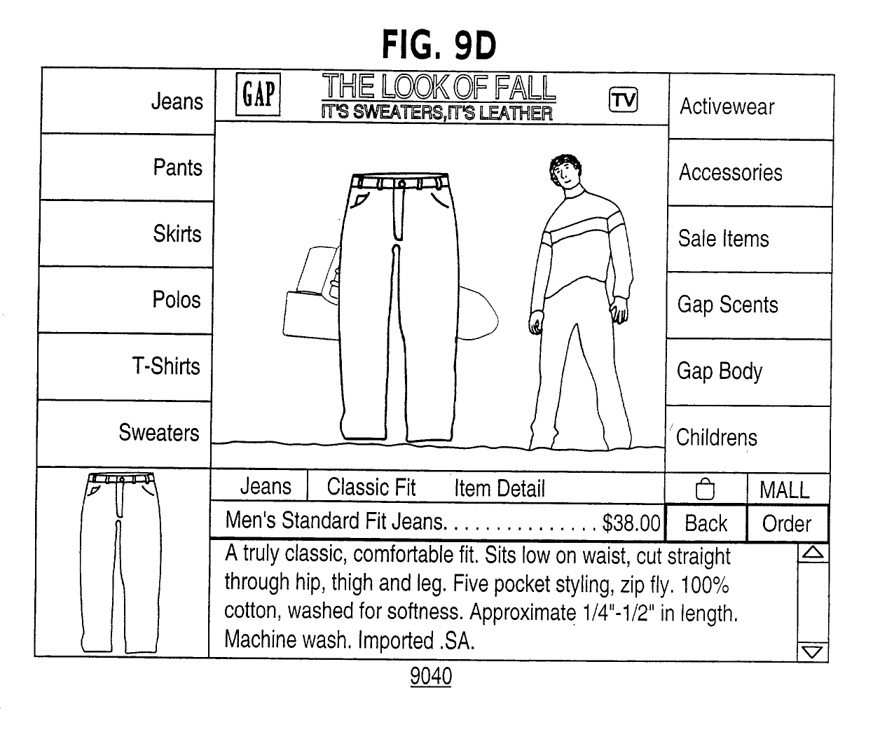

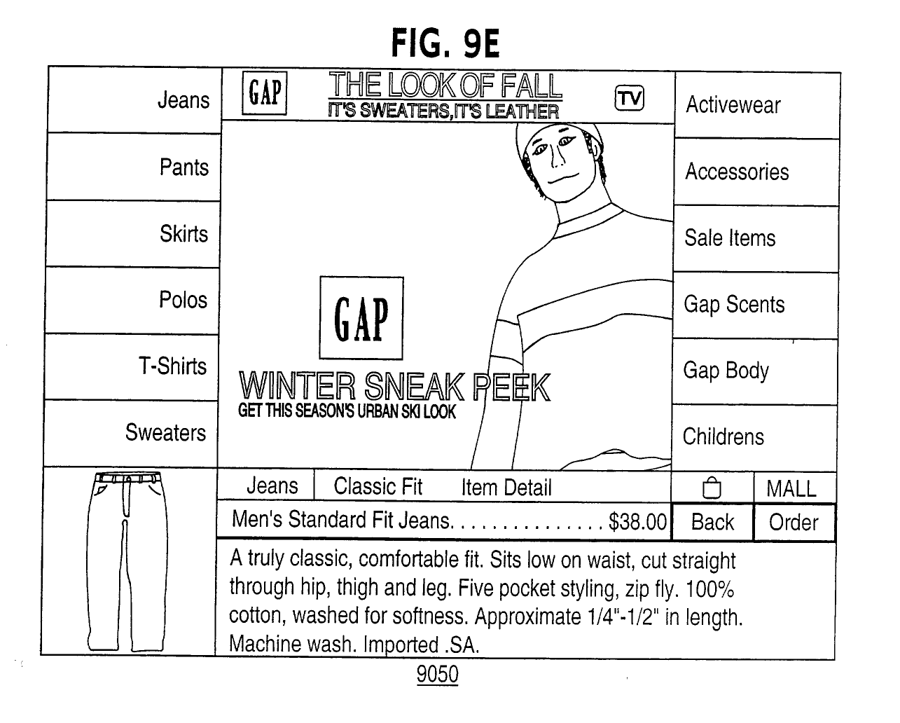

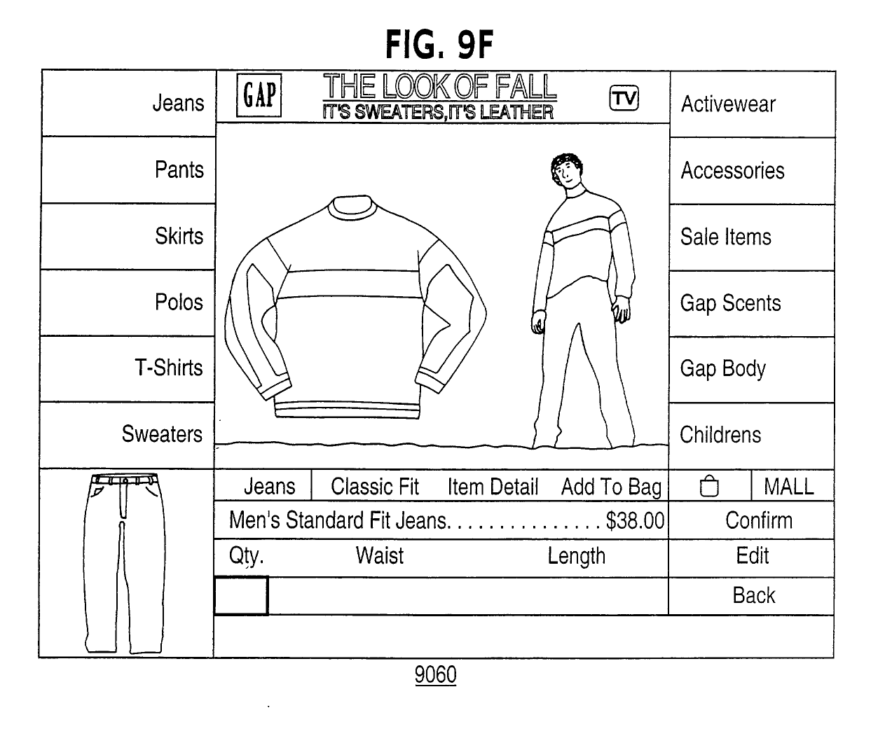

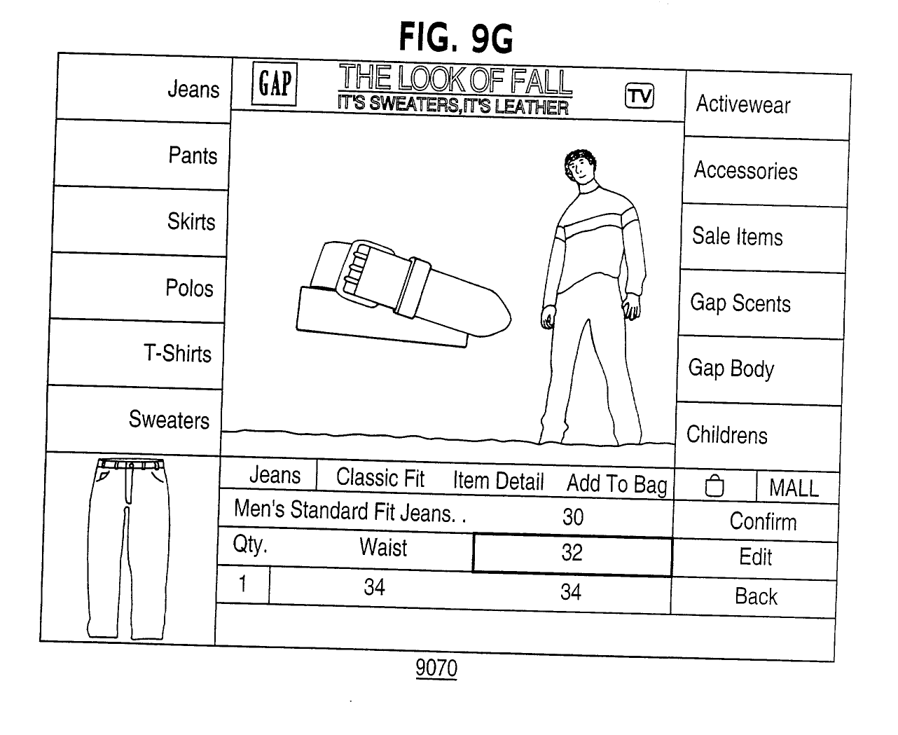

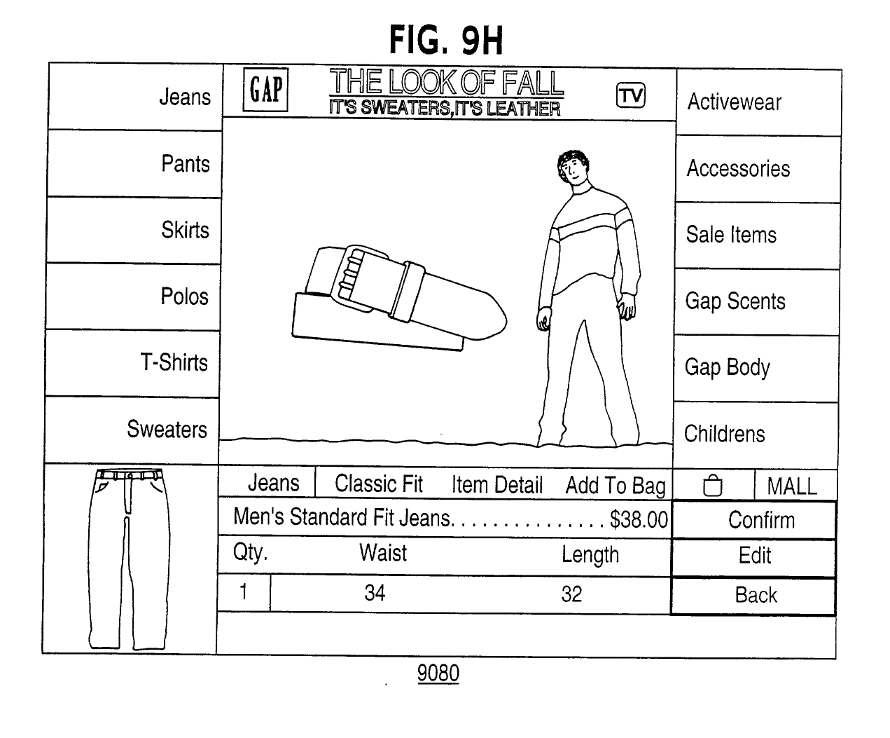

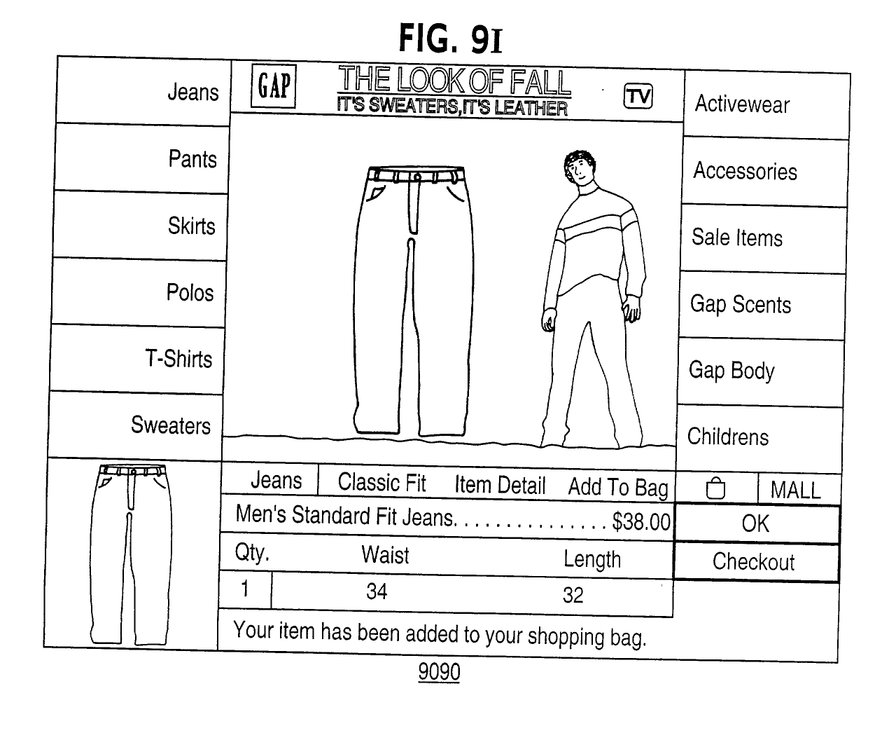

The tab items 3015 have a unique behavior when in-focus. When an up arrow is pressed, the user is bright not to the most adjacent, or most immediate item above it, but to whatever department (3005.n or 3020.n) had been in-focus prior. For example, if the Kitchen department tab 3015.1 is in-focus, an up arrow will bring into focus the Kitchen department button 3005.1 above. When a down arrow is pressed on a 3015 tab, it brings the user down to the first of the detail items 3035.1 below. If a left arrow is pressed, thumbnail image 3010 is brought into focus. The right arrow would bring the next tab 3015.n to the right into focus, if any. If there were no further tabs to the right, as is the case in FIG. 7 (but not in FIG. 9(D) 9040) a right arrow would bring the user to the checkout button 3025.1.

If a tab three tabs deep in the navigation 3015.3 were in-focus, and a left arrow were selected, the lower numbered tab to the left 3015.2 would be brought into focus. This would bring the user, in essence, one level out, or up, in the depth of navigation through the particular department.

Referring to detail box 3030, if any of the sub-departments within detail box 3030 are selected, then that sub-department's items are displayed in detail, and correspondingly, that sub-department would be highlighted as the right most tab 3015.n. For example, as shown in FIG. 7, if the Kitchen department 3015.1 is selected and the user scrolls down to the Cutlery detail item 3035.2 and presses select, a cutlery tab 3015.2 is added to the right of the Kitchen tab 3015.1. The detail of the cutlery items available would show up in detail box 3030. This behavior can be seen in FIG. 9(C) 9030 with respect to the Jeans department 3015.1 (3005.1) and the Classic Fit sub-department 3015.2.

Consistent with other items, the navigation of the 3035.n items is dependent on which one is currently in-focus. If the left arrow is pressed and one of detail items 3035.1-4 is in focus, thumbnail 3010 will be brought into focus. If the right arrow is pressed while any of items 3035.1-4 is in focus, the corresponding item 3035.5-8 will be brought into focus. If the left arrow is pressed while any one of detail items 3035.5-8 is in-focus, the corresponding detail item 3035.1-4 to the left is brought into focus. If a right arrow is pressed on any of detail items 3035.5-8, the in-focus box will be “wrapped” around to thumbnail item 3010.

Similarly, the up and down arrows function to bring the user to the respective detail item above or below the item currently in-focus. Except of course, if one of the bottom detail items (3035.4 or 3035.8) is selected, a tone will sound indicating that the user cannot navigate any lower. If one of the top detail items (3035.1 or 3035.5) is in-focus, an up arrow moves the in-focus box to the right most 3015.n tab.

In the event a department has too many tiers of sub-departments within it to be conveniently navigated using the 3015.n tab structure alone, the 3035.n detail items could be implemented with an alternative function. If the volume of sub-department and/or product data warrants it, detail items 3035.n can instead tune the user to a separate channel that accommodates that department alone. For example, a large store, such as a department store like Target, may want to present its automotive department in full. Rather than try to squeeze in as many automotive products as can be logically fit within the limited sub-department tabs 3015.n in this interface, an entire store could be brought up that is, in essence, Target's automotive department. Each of the department buttons (3005.n and 3020.n) would function the same way, but would be automotive sub-departments. Each of those could then have further sub departments 3035.n within it that would function as generally described above. The end result is a logical way to layer in additional levels of depth and navigation without adding complexity to the user experience.

The numeric indicator shown as part of the detail items 3035.n can have different functions as well. When the client application 12 receives the data in the broadcast signal regarding the products in the store, the client application 12 parses through the data and determines how many products are contained within each sub-department. It then displays that number to the user as part of detail item 3035.n. For example, it has calculated that number to be four in the case of the Cooking/Baking sub-department 3035.1 shown in FIG. 7, letting the user know that there are four items within that sub-department.

In the alternative, the number can also be used when detail item 3035.n is an actual product, rather than a sub-department. The numerical indicator can instead be implemented as an inventory number indicating to the user that a certain number of items are left in inventory. This is particularly useful in a traditional home shopping context where there are, in fact, limited inventories. The way this is implemented is for the CAS 16 to repeatedly communicate via the Internet with an inventory server belonging to the vendor that returns an up-to-date inventory number. That number would then be sent down in the data stream to the set top box where the client application can then display it to the user as part of the product detail item 3035.n.

Next are items 3025.1 and 3025.2. If select is pressed while either the checkout button 3025.1 or the mall button 3025.2 is in-focus, the user will be brought to the checkout screen or mall directory screen, respectively. If the up arrow is pressed while either of those buttons is in-focus, department 3020.6 is brought into focus. A down arrow will move the in-focus box to the most recently in-focus 3035.n item in the detail box 3030. A left arrow from 3025.2 will move focus to the checkout button 3025.1, and a left arrow from there will bring the right-most tab item 3015.n into focus. A right arrow from the mall button 3025.2, will “wrap” the user to the thumbnail image 3010.

Finally, video window 3040 is only navigable or usable when the user has pressed select on the thumbnail image 3010 and activated either a larger image or video. If the user presses select while an image is being viewed in the video window 3040, the in-focus box toggles back to the thumbnail image 3010.

The user is alerted to this functionality by the appearance of a triangle, arrow or other graphic indicator 3045, in the top right corner of a thumbnail 3010 indicating that there is either an on-demand video or larger image available to be viewed. When the user presses select while a thumbnail 3010 containing the graphic indicator 3045 is in focus, the corresponding video or image is viewed in the video window 3040. In addition, a similar graphic indicator 3050 or toolbar 3055 appears in video window 3040. The graphic indicator 3050 is preferably an arrow or triangle that appears in the bottom left corner of video window 3040 indicating that the user need only press select to toggle focus back to the thumbnail image 3010. If a video is playing, a graphical toolbar 3055 is displayed over the bottom of video window 3040 displaying common play, pause, rewind, and fast forward symbols that correspond to VCR-like functions. The viewer can thus operate the video on demand server by using the arrow keys and pressing select on one of the buttons on the toolbar 3055 to control the video. Either a stop button or a return toggle arrow 3050 would be included on or in conjunction with the toolbar 3055 to communicate that the viewer is done viewing the video and return focus to the thumbnail image 3010. At that point, the broadcast video, which had continued to run on another frequency during the VOD session, would again be displayed in video window 3040.

Referring generally to FIG. 7 and FIG. 8, the utility of this navigational scheme is the fact that there is a large amount of information presented to the user at all times; however, it is navigable with the simplicity of up, down, left and right arrows and one function button such as “enter,” or “select.” The result is that all of this information can be parsed or navigated by the user only clicking a minimal number of times to navigate to different areas of the screen and different levels of the store. That minimal number is preferably three or fewer, and by working through FIG. 7 and FIG. 8, one can determine that such a minimum number of clicks is all that is needed to get from nearly any functional area of the interface to any other area. For example, to get from any left department item 3005.n, one can navigate to any other area of the screen by pressing select, which brings tab 3015 into focus. From there, pressing a right arrow brings the checkout button 3025.1 into focus, effectively allowing navigation to reach the opposite side of the screen in just two clicks.

Referring to FIGS. 9(A)-(I), with reference to FIG. 7, the various implementations of item 3030, can be shown to take the user through a purchase sequence. The user navigates to the desired department 3005.n so that it is brought into focus 9010. When the user presses select on the desired department 3005.1, the in-focus box is moved to the first sub-department 3035.1 as depicted in FIG. 9(B) 9020. Upon pressing select on the desired sub-department 3035.n, the list of products available for sale within that sub-department is presented as detail items 3035.n and the sub-department name is displayed on the right-most tab 3015.2, as shown in FIG. 9(C) 9030. The user can view the details of a certain item by pressing the select button while a product detail item 3035.n is in-focus. This causes the application to retrieve from its cache of data on the set top box the actual detail about that item. For example, a chair might include a description of its characteristics, color, size, shape, height, dimensions, and price. This information is displayed in the detail box 3030 as shown in FIG. 9(D) 9040. The user can use the up and down arrows to scroll through text that exceeds the size of the detail box 3030. If the user presses the up arrow while the first line of text is displayed, the order button 9055 is brought into focus, as shown in FIG. 9(E) 9050.

When the user presses select while the order button 9055 is in-focus, an order placement process begins. A new right-most tab item 3035.4 is displayed indicating the order placement process has begun, as shown in 9060. In detail box 3030, products can now be configured. The order process will then vary depending on the degree of configuration of a particular item. For example, item configuration inputs such as color, size, and so forth, would be applicable for clothing and some household items, but would not be applicable to something such as a book, or video. These fields are made available to the user via pull-down menus and the use of direct numeric input via the remote control 86 using numbers 0-9 on the keypad, as shown in FIGS. 9(F) and (G) 9060 and 9070.

In a typical purchase sequence, the user can enter a quantity of 1-9, and then press select. The user would then be brought to further configuration fields such as waist and length, which can be configured using traditional drop-down menus, as shown in 9070. Once the item is completely configured in this way, the Confirm button is highlighted within item 3030, as shown in FIG. 9(H) 9080. The user need only press select to confirm the order.

When the user selects “Confirm,” a confirmation screen 9090 appears that summarizes the order that has been placed and provides a message to the user within item 3030 that the item, as configured, has been added to the user's shopping cart.

The shopping cart functionality is implemented in two ways. The preferable way is to implement it locally on the set top box where the client application uses the RAM available on the set top box to store the items the user has confirmed. The alternative implementation is to store the confirmed product orders in the HEDS 14.

When the user is done shopping through a number of stores and has confirmed one or more purchases, the user can go to the shopping cart to in effect “check out.” This can be done by navigating to the shopping cart button 3025.1. This brings the user to the check out area where he or she can check out by electing to finalize all purchases. The unique feature of the shopping cart is that a number of purchases can be aggregated within one shopping cart from a number of stores. This is unique in that many traditional electronic shopping carts allow shoppers to browse within one store and make purchases from within that one store alone. Here, the shopping cart is a unified system that allows the user to add items to the shopping cart from all of the stores available through the system. When the user is done shopping in all of the stores, he or she goes through one unitary checkout process.

It is also possible, however, to limit shopping cart functionality to the context of one store alone. This preference could be implemented either by the user, who may for some reason have a preference to check out of each store individually, or by the stores themselves that may not want their products to share a shopping cart implemented across all of the stores in the cable system.

Technically, the way the system works is that when the user wants to finalize purchases and check out, a message is sent through the digital broadband delivery system via the CAS 16 to the HEDS 14. There, the user's credentials—e.g., password, credit card information, name, address, etc.—are retrieved. The user's credentials in the HEDS 14 are associated with the unique identifier, or serial number, that identifies each and every individual set top box deployed in the field. It is the same number that the cable operator uses to perform its billing functions on a per-subscriber basis. Upon retrieving the credentials, the client application 12 prompts the user to input a password. Upon entering a password, the client application 12 verifies that the password the user has entered matches exactly the password that was just retrieved from the user's credentials in the HEDS 14.

Once the user has been authenticated by matching the password, the order information is combined with the user's credentials and sent to the HEDS 14 where all of the items stored in the shopping cart are assigned an order number. The HEDS 14 then forwards the completed order to the commerce control point 24, referring to FIG. 1, where it is parsed. The orders—complete with the user's credentials, and the SKU numbers of the products being purchased—are communicated electronically to each respective vendor's electronic fulfillment system 28, as shown in FIG. 4.

In the event purchases are confirmed and added to the shopping cart and the shopping cart is not checked out, either because the user has changed a channel without checking out, or otherwise, the application generates a message displayed in detail box 3030, warning the user that items are in the shopping cart and that those purchases need to be finalized. Based on whether the user elects to either finalize or abandon the shopping cart, either the purchases are made or that data is removed from the memory of the set top box. In the event the user fails to respond or abandons the application altogether, the, shopping cart data stored on the set top box is pushed out by the client application 12 to the HEDS 14 where it is stored. The next time the user initiates any type of one-on-one communication with the HEDS 14, a message is generated indicating that there was an abandoned shopping cart and the user is provided with the opportunity to make or reject those purchases.

After orders are placed, the system remains in regular communication with the fulfillment systems 28 of the relevant vendors, which at certain intervals communicate order status information. This information is then replicated through the database network and ultimately to the HEDS 14 that serves the relevant subscriber. When the subscriber wants to check the status of an order, he or she can select the Account button 2020 shown on the mall directory in FIG. 6. This launches an order status application provided by the client application 12 that sends a request to the HEDS 14. The HEDS 14 replies with the status of all of the client's orders from each of the relevant merchants, which is displayed in video window 2000. In addition to this communication method, when the database network receives a status from a merchant, an email alert can be generated and sent via the Internet to the email account of the subscriber.

Finally, if a user requires assistance with any aspect of utilizing the client application, the user can select the Help button 2040 shown on the mall directory screen in FIG. 6. This provides textual help displayed in the video window 2000, as well as video help provided by the video on demand server 1000 in the video window 2000.

What we claim is:

1. An interactive television commerce system, comprising:
a video broadcast distribution network having multiple in-band channels and an out-of-band data path;
a video on demand server configured to store a plurality of product video clips, each of the plurality of product video clips being stored in association with a respective unique clip identifier and having video images promoting a specific product and associated interactive data embedded in the video images;
a commerce transfer point server configured to broadcast, via a first of the multiple in-band channels, a first commerce related video program having video images promoting multiple different products and associated interactive data embedded in the video images, with the unique clip identifiers associated with those of the stored plurality of product video clips having video images promoting the multiple different products promoted in the video images of the first commerce related video program; and
a network controller configured (i) to receive, via the out-of-band data path, a first of the unique clip identifiers broadcast with the first commerce related video program and associated with a first of the stored plurality of product video clips having video images promoting a user selected one of the multiple different products promoted in the video images of the broadcast first commerce related video program, and (ii) to direct a broadcast, via a second of the multiple in-band channels, of the stored first product video clip, based on the received first unique clip identifier;
wherein the video on demand server is further configured to broadcast the stored first product video clip via the second in-band channel, based on the directive.

2. The system according to claim 1, wherein:
the video on demand server is further configured to store a plurality of commerce related video programs, each of the stored plurality of commerce related video programs having video images promoting multiple different products and associated interactive data embedded in the video images; and
the broadcast first commerce related video program is a first of the stored plurality of commerce related video programs.

3. The system according to claim 2, wherein:
the commerce transfer point server is further configured (i) to retrieve the first commerce related video program from the stored plurality of commerce related video programs and (ii) to insert the unique clip identifiers associated with those of the plurality of product video clips having video images promoting the multiple different products promoted by the video images in the first commerce related video program, into the retrieved first commerce related video program; and
the first commerce related video program is broadcast with the unique clip identifiers by broadcasting the retrieved first commerce related video program, with the inserted unique clip identifiers.

4. The system according to claim 1, further comprising:
a plurality of interactive client terminals, wherein a first of the plurality of interactive client terminals is configured (i) to tune to the first in-band channel, (ii) to receive the broadcast first commerce related video program via the tuned to first in-band channel, (iii) to display the video images and embedded interactive data in the received first commerce related video program, (iii) to receive an input representing a user interaction with the displayed interactive data to select the one product promoted in the displayed video images, and (iv) to transmit, based on the received user input and via the out-of-band data path, the first unique clip identifier;
wherein the network controller is configured to received the first unique clip identifier received by the commerce transfer point device is the first unique clip identifier transmitted by the first interactive client terminal;
wherein the first interactive client terminal is further configured (i) to tune to the second in-band channel, (ii) to receive the broadcast first product video clip via the tuned to second in-band channel, and (iii) to display the video images and associated interactive data in the received first product video clip.

5. The system according to claim 4, wherein each of the plurality of interactive client terminals is associated with a respective one of a plurality of unique terminal identifiers, and further comprising:
a database server configured to store the plurality of unique terminal identifiers;
wherein the first interactive client terminal is associated with a first of the plurality of unique terminal identifiers, and is further configured to transmit, based on the received user input, the first unique terminal identifier with the first unique clip identifier;
wherein the network controller is further configured to received the transmitted first unique terminal identifier and to direct the broadcast of the stored first product video clip, based also on the received first unique terminal identifier.

6. The system according to claim 1, wherein:
the video broadcast distribution network is a digital broadband distribution network; and
the second in-band channel is a QAM modulated video stream.

7. The system according to claim 1, wherein:
the first commerce related video program is a first of a plurality of commerce related video programs, each of the plurality of commerce related video programs having video images promoting multiple different products of a different one of a plurality of product vendors and associated interactive data embedded in the video images; and
the commerce transfer point server is further configured to broadcast, via a third of the multiple in-band channels, a second of the plurality of commerce related video programs with the unique clip identifiers associated with those of the stored plurality of product video clips having video images promoting the multiple different products promoted in the video images of the second commerce related video program.

8. The system according to claim 1, wherein:
the first commerce related video program is a first of a plurality of commerce related video programs, each of the plurality of commerce related video programs having video images promoting multiple different products of a different one of a plurality of product vendors and associated interactive data embedded in the video images;
the commerce transfer point server is further configured to broadcast, via the first in-band channel, a second of the plurality of commerce related video programs with the unique clip identifiers associated with those of the stored plurality of product video clips having video images promoting the multiple different products promoted in the video images, of the second commerce related video program;
the first commerce related video program is broadcast during a first time period and the second commerce related video program is broadcast during a second time period different than and not overlapping with the first time period.

9. A method for performing interactive television commerce over a video broadcast distribution network having multiple in-band channels and an out-of-band data path, comprising:
storing (i) a plurality of commerce related video programs, each of the plurality of commerce related video programs having video images promoting multiple different products and associated interactive data embedded in the video images, and (ii) a plurality of product video clips, each of the plurality of product video clips being stored in association with a respective unique clip identifier, and having video images promoting a specific product and associated interactive data embedded in the video images;
broadcasting, via a first of the multiple in-band channels, a first of the stored plurality of commerce related video programs, and the stored unique clip identifiers associated with those of the stored plurality of product video clips having video images promoting the multiple different products promoted in the video images of the first commerce related video program;
receiving, via the out-of-band data path, a first of the broadcast unique clip identifiers associated with a first of the stored plurality of product video clips having video images promoting a user selected one of the multiple different products promoted in the video images of the broadcast first commerce related video program; and
broadcasting, via a second of the multiple in-band channels, the stored first product video clip, based on the received first unique clip identifier.

10. The method according to claim 9, further comprising:
issuing a demand to broadcast the stored first product video clip via the second in-band channel, based on the received first unique clip identifier;
wherein the stored first product video clip is broadcast in accordance with the issued demand.

11. The system according to claim 9, further comprising:
retrieving the stored first commerce related video program; and
inserting the unique clip identifiers associated with those of the plurality of product video clips having video images promoting the multiple different products promoted by the video images in the first commerce related video program, into the retrieved first commerce related video program;
wherein the first commerce related video program is broadcast with the unique clip identifiers by broadcasting the retrieved first commerce related video program, with the inserted unique clip identifiers.

12. The method according to claim 9, further comprising:
tuning to the first in-band channel;
receiving the broadcast first commerce related video program via the tuned to first in-band channel;
displaying the video images and embedded interactive data in the received first commerce related video program to a user;
receiving an input representing an interaction directed by the user with the displayed interactive data to select the one product promoted in the displayed video images;
transmitting, based on the received user input and via the out-of-band data path, the first unique clip identifier via the out-of-band data path, wherein the received first unique clip identifier is the first unique clip identifier transmitted via the out-of-band data path;
tuning to the second in-band channel;
receiving the broadcast first product video clip via the tuned to second in-band channel; and
displaying the video images and associated interactive data in the received first product video clip to the user.

13. The method according to claim 12, further comprising:
storing a plurality of unique user terminal identifiers;
transmitting, based on the received user input, a first of the plurality of unique terminal identifiers with the first unique clip identifier;
receiving the transmitted first unique terminal identifier;
wherein the broadcast of the stored first product video clip is directed based also on the received first unique terminal identifier.

14. The method according to claim 9, wherein:
the video broadcast distribution network is a digital broadband distribution network; and
the second in-band channel is a QAM modulated video stream.

15. The method according to claim 9, further comprising:
broadcasting a second of the stored plurality of commerce related video programs and the unique clip identifiers associated with those of the stored plurality of product video clips having video images promoting the multiple different products promoted in the video images of the second commerce related video program;
wherein the second commerce related video program and the unique clip identifiers are broadcast via one of (i) a third of the multiple in-band channels and (ii) the first in-band channel;
wherein if the second commerce related video program and the unique clip identifiers are broadcast via the first in-band channel, the first commerce related video program is broadcast during a first time period and the second commerce related video program is broadcast during a second time period different than and not overlapping with the first time period.

16. The method according to claim 15, wherein:
wherein the second commerce related video program and the unique clip identifiers are broadcast via the third in-band channel simultaneously with the broadcast of the first commerce related video program and the unique clip identifiers via the first in-band.

17. An interactive television commerce architecture, comprising:
a video broadcast distribution network having multiple in-band channels and an out-of-band data path;
a video on demand server storing (i) a plurality of commerce related video programs, each of the stored plurality of commerce related video programs having video images promoting multiple different products and associated interactive data embedded in the video images, and (ii) a plurality of product video clips, each of the plurality of product video clips being stored in association with a respective unique clip identifier and having video images promoting a specific product and associated interactive data embedded in the video images;
a commerce transfer point server interconnected to the video on demand server and to one or more of the multiple in-band channels to broadcast the stored plurality of commerce related video programs with the unique clip identifiers associated with those of the stored plurality of product video clips having video images promoting the multiple different products promoted in the video images of the first commerce related video program; and
a network controller interconnected to the video on demand server to direct a broadcast of the stored plurality of product video clips;
wherein the video on demand server is interconnected to one or more of the multiple in-band channels to broadcast the stored plurality of product video clips, based on the directive.

18. The architecture according to claim 17, further comprising:
a plurality of interactive client terminals, interconnected to the multiple in-band channels to receive the broadcast plurality of commerce related video programs and the broadcast plurality of product video clips, and interconnected to the out-of-band data path to transmit data corresponding to user inputs to the network controller.

19. The architecture according to claim 18, wherein each of the plurality of interactive client terminals is associated with a respective one of a plurality of unique terminal identifiers, and further comprising:
a commerce transfer point database interconnected to the commerce transfer point server and storing the plurality of unique terminal identifiers.

20. The architecture according to claim 17, wherein:
the video broadcast distribution network is a digital broadband distribution network.
